(19) United States
(12) Patent Application Publication
(10) Pub. No.: US 2026/0286103 A1
(43) Pub. Date: Sep. 24, 2026

(54) SELF-HEALING POLYMERS

(71) Applicant: Vrije Universiteit Brussel, Brussels (BE)

(72) Inventors: Aleix Costa Cornellà, Brussels (DE); Francesca Furia, Brussels (DE); Joost Brancart, Brussels (DE); Guy Van Assche, Brussels (DE)

(73) Assignee: Vrije Universiteit Brussel, Brussels (BE)

(21) Appl. No.: 19/476,568

(22) PCT Filed: Apr. 24, 2024
(86) PCT No.: PCT/EP2024/061156

§ 371 Date: Oct. 17, 2025

(30) Foreign Application Priority Data
Apr. 25, 2023 (EP) 23169905.9
Dec. 19, 2023 (EP) 23218068.7

(51) Int. Cl. C08K 11/00; B29C 48/00; B29C 48/05; B33Y 70/00; C08J 3/24

(52) U.S. Cl. CPC C08K 11/00; B29C 48/022; B29C 48/05; C08J 3/24; B33Y 70/00

(57) ABSTRACT

The present invention relates to self-healing polymer compositions and uses thereof in various domains, such as additive manufacturing and robotics. Furthermore, the present invention relates to a method for preparing said self-healing polymers, and to structures comprising said polymers.

### FIELD OF THE INVENTION

The present invention relates to self-healing polymer compositions and uses thereof in various domains, such as additive manufacturing and robotics. Furthermore, the present invention relates to a method for preparing said self-healing polymers, and to structures comprising said polymers.

### BACKGROUND TO THE INVENTION

In the field of robotics, more specifically in the application of soft grippers, it has been proven beneficial to use self-healing materials capable of healing a certain amount of damage sustained during its use. Soft grippers can for instance be used for fruit and vegetable picking, where the soft grippers come in close contact with sharp objects (e.g. sharp twigs, thorns, plastic or glass). As a result, macroscopic damage (e.g. perforations, cuts and ruptures) occurs over time and negatively impacts the performance of these grippers. Robots are also used in remote applications, like search-and-recovery or environmental investigations in (aero) space or marine environments, where it becomes difficult to repair or replace a damaged part.

Self-healing materials already exist today and have the ability to repair damage without the need to replace these materials. Depending on the type of self-healing material, the damage can be repaired with or without application of an external stimulus such as heat, pH changes, and light. To obtain a self-healing material, exchangeable dynamic bonds are typically introduced into polymer networks. In response to one or more external stimuli, the dynamic bonds creating crosslinks in the polymer network are able to shuffle, which permits the network to (be) reshape (d), preferably back to its original form. Ideally these materials possess the malleability of thermoplastics and the dimensional stability of thermosets, thereby providing a unique combination of physical properties, such as self-healing and improved recyclability.

Polymer networks that incorporate dynamic covalent bonds are called covalent adaptable networks (CANs). These covalent adaptable networks can be divided into two subgroups based on how the exchange reaction proceeds, namely dissociative and associative or degenerate mechanisms. During a dissociative exchange, the dynamic bond dissociates before a new one is formed, while during an associative or degenerate exchange, the reaction proceeds via an intermediate (or transition) state in which the entities involved in the exchange are chemically linked together. The behavior of the covalent adaptable networks largely depends on these different mechanisms.

One of the earliest examples of a covalent adaptable network (CAN) following a dissociative mechanism is the Diels-Alder (DA) polymer network, which is based on a reversible Diels-Alder reaction between functional diene and dienophile groups. The Diels-Alder bonds can therefore be considered dissociative covalent bonds (DCBs). The downside of a polymer network crosslinked by dissociative covalent bonds, such as Diels-Alder bonds, is that the viscosity abruptly drops upon heating, which may lead to mechanical instability. Other disadvantages may be the susceptibility to creep or the vulnerability to certain solvents.

In contrast to the dissociative Diels-Alder network, vitrimers are polymer networks containing dynamic covalent bonds that follow an associative or degenerate exchange mechanism, namely associative covalent bonds (ACBs). The evolution of viscosity of vitrimers as a function of temperature typically obeys the Arrhenius law. Vitrimers typically have a better stability and keep the same crosslink density, but due to the linear decrease of viscosity with temperature, samples that heal at reasonable temperatures tend to be susceptible to large creep.

It is therefore an object of the current invention to address the problems associated with self-healing polymers known in the art, by providing novel self-healing polymer compositions.

### SUMMARY OF THE INVENTION

According to a first aspect, the present invention provides a polymer network composition comprising a transesterification catalyst and a polymer network dually crosslinked by Diels-Alder reaction products of maleimide groups and furan groups as Dissociative Covalent Bonds (DCBs) and ester groups as Associative Covalent Bonds (ACBs), wherein the dually crosslinked network further comprises hydroxyl groups, and wherein the amount of dissociative covalent bonds, relative to the sum of dissociative and associative covalent bonds (DCBs+ACBs) crosslinking the network, is at least 5%.

Polymer network compositions as defined in the first aspect, combining Diels-Alder bonds as dissociative covalent bonds and ester bonds as associative covalent bonds as crosslinking moieties of the polymer network, in the presence of a transesterification catalyst, have relaxation dynamics that may for instance be tailored for a specific application, for the timeframe and/or temperature wherein the material is typically used, and/or for its processing properties.

During the healing process at an elevated temperature, the dynamic Diels-Alder bonds (representing the DCBs of the polymer network) of the polymer network can be thermally dissociated in a reversible fashion, leading to dissociative crosslinks being broken, and new crosslinks being formed. At the same time, the ester bonds (representing the ACBs of the polymer network) are able to undergo transesterification with hydroxyl groups in the polymer network in the presence of the transesterification catalyst, leading to associative crosslinks being exchanged between existing ester bonds and hydroxyl groups.

According to an embodiment, the present invention provides the dually crosslinked polymer network composition as defined herein, wherein the amount of dissociative covalent bonds, relative to the sum of dissociative and associative covalent bonds crosslinking the network, is at least 10%, preferably from 20 to 99%, more preferably from 30 to 95%, even more preferably from 40 to 90%, yet even more preferably from 50 to 80%.

According to a further embodiment, the present invention provides the dually crosslinked polymer network composition as defined herein, wherein at least part of the ester groups providing the associative covalent bonds of the dually crosslinked polymer network, and at least part of the hydroxyl groups comprised in the dually crosslinked polymer network, are present as β-hydroxyesters.

According to a further embodiment, the present invention provides the dually crosslinked polymer network composition as defined herein, wherein the β-hydroxyesters are represented by formula (I);

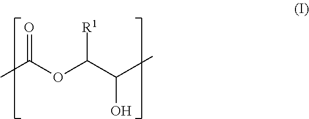

wherein R₁ is selected from —H, —C₁₋₁₈alkyl, and —C₂₋₁₈alkenyl; wherein each of said —C₁₋₁₈alkyl, and —C₂₋₁₈alkenyl is optionally and independently substituted with from 1 to 3 substituents selected from -halo, —OH, —C₁₋₆alkyl, —C₁₋₆alkenyl, and —O—C₁₋₆alkyl.

According to a further embodiment, the present invention provides the dually crosslinked polymer network composition as defined herein, wherein at least part of the furan groups of the Diels-Alder bonds are connected to the polymer network via a β-hydroxyester linker.

According to a further embodiment, the present invention provides the dually crosslinked polymer network composition as defined herein, wherein at least part of the furan groups of the Diels-Alder bonds are connected to the polymer network via a β-hydroxyester linker, as represented by formula (II);

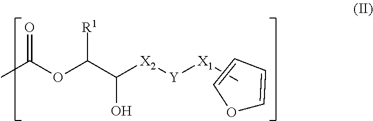

wherein
R₁ is selected from —H, —C₁₋₁₈alkyl, and —C₂₋₁₈alkenyl; wherein each of said —C₁₋₁₈alkyl, and —C₂-18alkenyl is optionally and independently substituted with from 1 to 3 substituents selected from -halo, —OH, —C₁₋₆alkyl, —C₁₋₆alkenyl, and —O—C₁₋₆alkyl;
Y is selected from —C₁₋₆alkylene-, —O—, —C(O)O—, and —OC(O)—; and
X₁, and X₂ are independently selected from —C₁₋₆alkyl-, —C₂₋₆alkenyl-, and —C₁₋₆alkyl-O—; wherein each of said —C₁₋₆alkyl-, —C₂₋₆alkenyl-, and —C₁₋₆alkyl-O— is optionally and independently substituted with from 1 to 3 substituents selected from -halo, —OH, —C₁₋₆alkyl, —C₁₋₆alkenyl, and —O—C₁₋₆alkyl.

According to a further embodiment, the present invention provides the dually crosslinked polymer network composition as defined herein, further comprising a radical scavenger.

According to a further embodiment, the present invention provides the dually crosslinked polymer network composition as defined herein, wherein the transesterification catalyst is selected from zinc acetylacetonate, zinc acetate, dibutylin oxide, tin (II) 2-ethylhexanoate, triazabicyclodecene, 1-methylimidazole, triphenylphospine, or any combination thereof.

According to a second aspect, the present invention provides a method for preparing the polymer network composition, comprising a dually crosslinked polymer network, as defined herein, the method comprising the steps of:
a) providing a first pre-polymer comprising carboxylic acid groups;
b) functionalizing a first portion of carboxylic acid groups of the first pre-polymer with a furan introducing reagent in the presence of a transesterification catalyst, thereby obtaining a furan-functionalized pre-polymer comprising a second portion of carboxylic acid groups;
c) adding a second pre-polymer comprising oxirane or epoxy groups and a third pre-polymer comprising maleimide groups to the furan-functionalized pre-polymer, thereby obtaining a pre-polymer mixture; and
d) stirring the pre-polymer mixture at an elevated temperature, thereby obtaining the polymer network composition;
   wherein the first portion is at least 5% of the total amount of carboxylic acid groups of the first pre-polymer.

The method as defined in the second aspect, wherein a first pre-polymer comprising carboxylic acid groups is first reacted with a furan introducing reagent in the presence of a transesterification catalyst to functionalize at least 5% of the carboxylic groups (first portion), and subsequently reacting the furan-functionalized pre-polymer, still comprising remaining carboxylic groups (second portion), with a second pre-polymer comprising oxirane or epoxy groups and a third pre-polymer comprising maleimide groups, provides a polymer network composition as defined herein.

According to an embodiment, the present invention provides the method as defined herein, wherein a radical scavenger is added in any one of the steps before the pre-polymer mixture is stirred at the elevated temperature.

According to a further embodiment, the present invention provides the method as defined herein, wherein the pre-polymer comprising maleimide groups has a functionality of at least 2, in particular wherein the pre-polymer comprising maleimide groups is a bismaleimide.

According to another aspect, the present invention provides the use of the polymer network composition as defined herein.

According to an embodiment, the present invention provides the use of the polymer network composition as defined herein, as self-healing material.

According to a further embodiment, the present invention provides the use of the polymer network composition as defined herein, in the manufacturing of 1D, 2D or 3D structures, in particular in the manufacturing of robotic components or tyres.

The polymer network composition as defined herein may be particularly suited to be used as self-healing material, such as in the field of robotics, more specifically in the subfield of soft robotics.

According to a further embodiment, the present invention provides the use of the polymer network composition as defined herein, in a manufacturing method selected from the list comprising: filament extrusion, extrusion-based printing techniques, selective laser sintering, injection molding, compression molding, casting, soft lithography.

According to a further embodiment, the present invention provides the use of the polymer network composition as defined herein, wherein said extrusion-based printing techniques are selected from the list comprising: fused filament fabrication, direct ink writing and the like.

According to yet another aspect, the present invention provides a 1D, 2D or 3D structure comprising the polymer network composition as defined herein.

### BRIEF DESCRIPTION OF THE DRAWINGS

With specific reference now to the figures, it is stressed that the particulars shown are by way of example and for purposes of illustrative discussion of the different embodiments of the present invention only. They are presented in the cause of providing what is believed to be the most useful and readily description of the principles and conceptual aspects of the invention. In this regard, no attempt is made to show structural details of the invention in more detail than is necessary for a fundamental understanding of the invention. The description provided with the drawings makes apparent to those skilled in the art how the several forms of the invention may be embodied in practice.

FIG. 1, also abbreviated as FIG. 1, shows the stress relaxation of polymer network composition according to embodiments of the invention, with different relative amounts of DA bonds as dissociative covalent bonds, at different temperatures: 1A shows the relaxation behavior of Comparative example A (100% DA bonds), 1B shows the relaxation behavior of Comparative example B (0% DA bonds), and 1C shows the relaxation behavior at 140° C. of Examples 8a-e.

FIG. 2, also abbreviated as FIG. 2, shows the storage modulus of Examples 8a-8e and Comparative examples A-B, with different relative amounts of DA bonds as dissociative covalent bonds, at different temperatures.

FIG. 3, also abbreviated as FIG. 3, shows creep behavior of Examples 8a-8e and Comparative examples A-B, with different relative amounts of DA bonds as dissociative covalent bonds, at different temperatures.

FIG. 4, also abbreviated as FIG. 4, shows a representation of the different steps with respect to showing the shape-memory properties of a sample prepared according to Example 8d.

### DETAILED DESCRIPTION OF THE INVENTION

The present invention will now be further described. In the following paragraphs, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

When describing the compounds of the invention, the terms used are to be construed in accordance with the following definitions, unless a context dictates otherwise:

The term “alkyl” by itself, or as part of another substituent, refers to a fully saturated hydrocarbon of Formula CₓH₂ₓ or CₓH₂ₓ₊₁ wherein x is a number greater than or equal to 1. Generally, alkyl groups of this invention comprise from 1 to 20 carbon atoms. Alkyl groups may be linear or branched and may be substituted as indicated herein. When a subscript is used herein following a carbon atom, the subscript refers to the number of carbon atoms that the named group may contain. Thus, for example, C₁₋₄alkyl means an alkyl of one to four carbon atoms. Examples of alkyl groups are methyl, ethyl, n-propyl, i-propyl, butyl, and its isomers (e.g. n-butyl, i-butyl and t-butyl); pentyl and its isomers, hexyl and its isomers, heptyl and its isomers, octyl and its isomers, nonyl and its isomers; decyl and its isomers. C₁-C₆alkyl includes all linear, branched, or cyclic alkyl groups with between 1 and 6 carbon atoms, and thus includes methyl, ethyl, n-propyl, i-propyl, butyl and its isomers (e.g. n-butyl, i-butyl and t-butyl); pentyl and its isomers, hexyl and its isomers, cyclopentyl, 2-, 3-, or 4-methylcyclopentyl, cyclopentylmethylene, and cyclohexyl. An optionally substituted alkyl refers to an alkyl having optionally one or more substituents (for example 1, 2, 3 or 4).

The term “alkenyl” by itself, or as part of another substituent, refers to straight-chain, cyclic, or branched-chain hydrocarbon radicals containing at least one carbon-carbon double bond. Thus, for example, C₂₋₄alkenyl means an alkenyl of two to four carbon atoms. Examples of alkenyl radicals include ethenyl (vinyl), E- and Z-propenyl, allyl, isopropenyl, E- and Z-butenyl, E- and Z-isobutenyl, E- and Z-pentenyl, E- and Z-hexenyl, E,E-, E,Z-, Z,E-, Z,Z-hexadienyl, and the like.

An optionally substituted alkenyl refers to an alkenyl having optionally one or more substituents (for example 1, 2, 3 or 4). C₁alkenyl refers to a vinyl moiety, where the C₁ substituent together with the carbon to which the substituent is connected, constitutes the carbon-carbon double bond.

As used in the specification and the appended claims, the singular forms “a”, “an”, and “the” include plural referents unless the context clearly dictates otherwise. By way of example, “a compound” means one compound or more than one compound. The terms described above and others used in the specification are well understood to those in the art. The compounds of the present invention can be prepared according to the reaction scheme provided in the examples hereinafter, but those skilled in the art will appreciate that these are only illustrative for the invention and that the compounds of this invention can be prepared by any of several standard synthetic processes commonly used by those skilled in the art of organic chemistry.

As stated hereinbefore, according to a first aspect, the present invention provides a polymer network composition comprising a transesterification catalyst and a polymer network dually crosslinked by Diels-Alder reaction products of maleimide groups and furan groups as Dissociative Covalent Bonds (DCBs) and ester groups as Associative Covalent Bonds (ACBs), wherein the dually crosslinked network further comprises hydroxyl groups, and wherein the amount of dissociative covalent bonds, relative to the sum of dissociative and associative covalent bonds crosslinking the network, is at least 5%.

It was found that a polymer network composition as defined in the first aspect, combining both Diels-Alder reaction products of maleimide groups and furan groups (DA bonds) as DCBs and ester groups as ACBs as crosslinking moieties of the polymer network, in the presence of a transesterification catalyst, provides tailored relaxation dynamics. The material, and its relaxation dynamics, may for instance be tailored for a specific application, for the timeframe and/or temperature wherein the material is typically used and/or for its processing properties.

In particular, it was found that the processability, in terms of quality and energy efficiency, of a polymer network may improve by having some dissociative Diels-Alder bonds, relative to a polymer network solely having associative bonds. During processing, a network with 0% DA was for instance pressed at 210° C. for 1 h at a pressure of 2t, while a network with 30% DA was pressed at 185° C. for 1 h at a pressure of 2t and a network with 50% DA was pressed at 170° C. for 10′ at a pressure of 2t, to obtain a reprocessed polymer network.

As mentioned hereinbefore, the dynamic Diels-Alder bonds (representing the DCBs of the polymer network) of the polymer network can be thermally dissociated in a reversible fashion during the healing process at an elevated temperature, leading to dissociative crosslinks being broken, and new crosslinks being formed. At the same time, the ester bonds (representing the ACBs of the polymer network) are able to undergo transesterification with hydroxyl groups in the polymer network in the presence of the transesterification catalyst during the healing process at an elevated temperature, leading to associative crosslinks being exchanged between existing ester bonds and hydroxyl groups. The presence of hydroxyl groups in the dually crosslinked polymer network thereby enables the transesterification of the ester crosslinks.

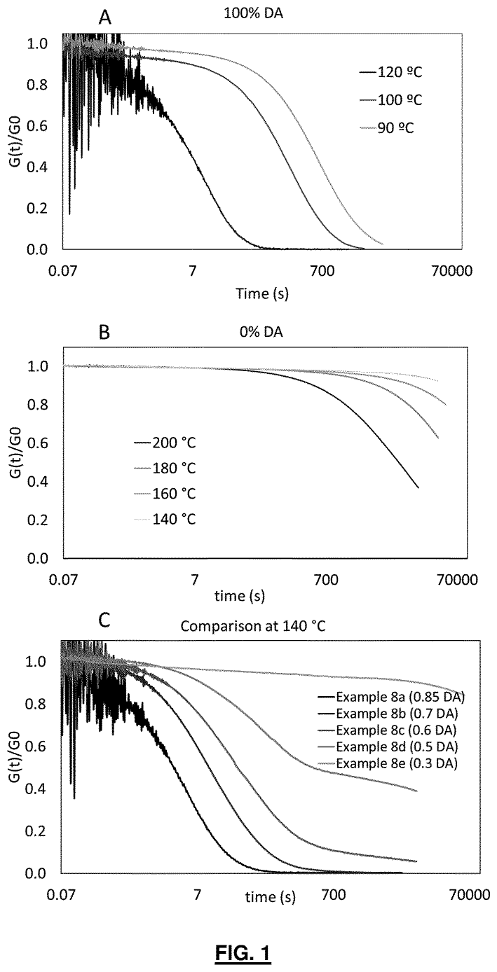

FIG. 1 shows that a polymer network composed exclusively of DCBs, i.e. Diels-Alder bonds (100% DA), relaxes external stress several orders of magnitude faster than a polymer network composed exclusively of associative covalent bonds (0% DA), at a given temperature.

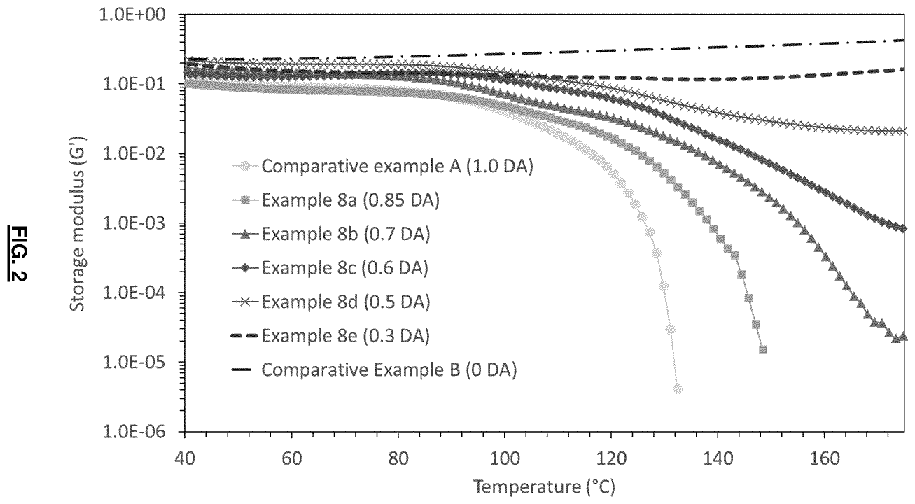

FIG. 2 shows that the behavior in terms of mechanical properties of materials with different relative amounts of DA bonds as dissociative covalent bonds is very similar close to room temperature but changes several orders of magnitude at higher temperatures. Again, providing tools to tailor the behavior of the material.

Additionally, the crosslinked polymer composition as defined herein may have improved self-healing kinetics and/or may be less susceptible to creep, compared to polymer networks having solely associative bonds or solely dissociative bonds. The crosslinked polymer composition as defined herein may have a more linear decrease of viscosity with temperature and/or may be less susceptible to creep and/or may be less susceptible to deterioration due to exposure to solvents, compared to polymer networks having solely dissociative bonds.

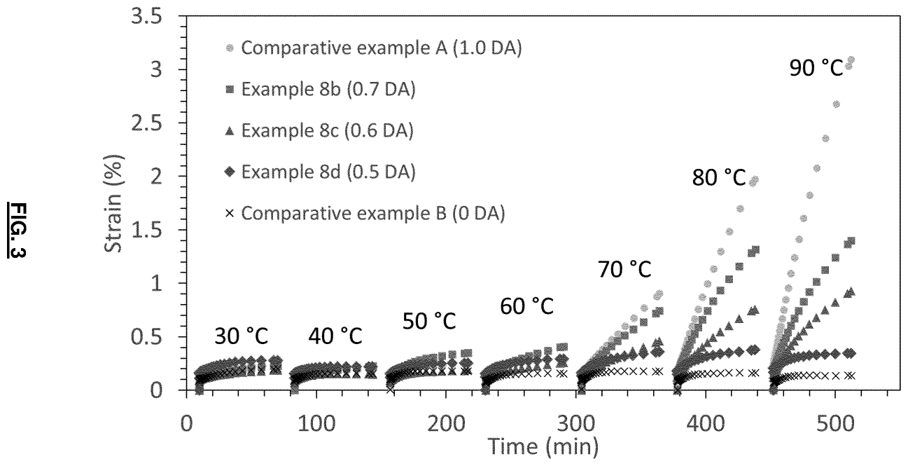

FIG. 3 shows that the creep behavior of materials with different relative amounts of DA bonds as dissociative covalent bonds is again very similar close to room temperature, but at higher temperatures, materials with a higher relative amount of DA bonds as dissociative covalent bonds are more prone to creep.

It should be appreciated that the terms “crosslinked polymer”, “polymer network”, and “crosslinked polymer network” are used synonymously for a polymer network with at least some degree of crosslinking.

As mentioned herein and unless provided otherwise, the term “Diels-Alder reaction products of maleimide groups and furan groups” should be understood as the result of a Diels-Alder reaction between a furan group and a maleimide group, resulting in either isomer of the cycloadduct, referred to as “Diels-Alder bond”, or “DA bond”. As will be described in further detail hereinafter, the Diels-Alder bonds may be formed by reaction of a furan-functionalized pre-polymer and a pre-polymer comprising maleimide groups, leading to a polymer or polymer network comprising Diels-Alder reaction products of maleimide groups and furan groups as dissociative crosslinking moieties. The Diels-Alder reaction, forming the Diels-Alder bonds, is an equilibrium reaction making the formed crosslink bonds dynamic. Bonds are constantly broken and reformed in said dynamic network over time. Diels-Alder bonds are strong covalent bonds that can be thermally dissociated or mechanically broken and reformed in a reversible fashion, leading to self-healing characteristics.

Scheme 1 provides a schematic representation of a Diels-Alder reaction between a furan group A and maleimide group B resulting in a Diels-Alder reaction product.

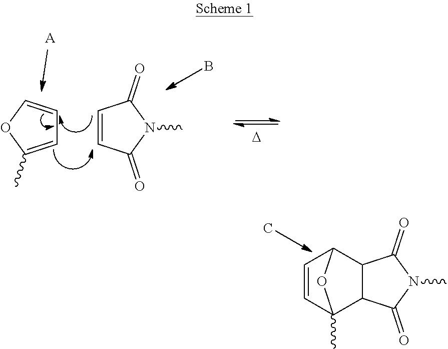

If Diels-Alder networks are damaged, Diels-Alder bonds and hydrogen bonding interactions are locally broken in a reversible fashion, resulting in active fracture surfaces. The hydrogen donors and acceptors and the newly formed furan and maleimide functional groups, resulting from the reversible mechanical breaking of the Diels-Alder bonds, autonomously reform the broken bonds, thus restoring the polymer network structure and related properties. To effectuate healing of this damaged area, a first step of the self-healing process entails bringing the fractured surfaces back into contact. Depending on the size of the damage, manual intervention or intervention by the robotic system might be necessary in order to actively push both fractured surfaces back together, for example when the material is cut all the way through, and two separate pieces are formed. Such full cuts require both fractured pieces to be pushed back together to initiate the healing process. In this case, it is of importance that both pieces are pushed back together as soon as possible after the damage occurred.

As described hereinbefore, the amount of Diels-Alder reaction products of maleimide groups and furan groups (DA bonds) as dissociative covalent bonds crosslinking the polymer network, relative to the total amount of crosslinks of the polymer network, being the sum of the amount of DA bonds as dissociative covalent bonds and the amount of ester groups as associative covalent bonds, both crosslinking the polymer network, may have an influence on the properties of the crosslinked polymer composition. In useful embodiments of the invention, the amount of dissociative covalent bonds, relative to the sum of dissociative and associative covalent bonds crosslinking the network, is at least 5%, such as 5%, 10%, 15% 20%, 25%, 30%, 35%, 40%, 50%, 60%, 70%, 75%, 80%, 85%, 90%, 95%, or 99%. In a particular embodiment, the present invention provides a polymer network composition as defined herein, wherein the amount of dissociative covalent bonds, relative to the sum of dissociative and associative covalent bonds crosslinking the network, is at least 10%, preferably from 20 to 99%, more preferably from 30 to 95%, even more preferably from 40 to 90%, yet even more preferably from 50 to 80%.

It was found that the transesterification catalyst can be any catalyst known in the art that catalyzes the transesterification of an ester group and a hydroxyl group. In useful embodiments of the invention, the transesterification catalyst can be a metal catalyst, an organocatalyst, an acid catalyst, a base catalyst, or any combination thereof. Suitable examples of a transesterification catalyst are zinc acetylacetonate, zinc acetate, dibutylin oxide, tin (II) 2-ethylhexanoate, triazabicyclodecene, 1-methylimidazole, triphenylphospine, and the like. In an embodiment, the present invention provides a polymer network composition as defined herein, wherein the transesterification catalyst is selected from the list comprising: zinc acetylacetonate, zinc acetate, dibutylin oxide, tin (II) 2-ethylhexanoate, triazabicyclodecene, 1-methylimidazole, triphenylphospine, and any combination thereof. In a particular embodiment, the present invention provides a polymer network composition as defined herein, wherein the transesterification catalyst is a metal catalyst selected from the list comprising: zinc acetylacetonate, zinc acetate, dibutylin oxide, tin (II) 2-ethylhexanoate, and any combination thereof. In another particular embodiment, the present invention provides a polymer network composition as defined herein, wherein the transesterification catalyst is an organocatalyst selected from the list comprising: triazabicyclodecene, 1-methylimidazole, triphenylphospine, and any combination thereof.

It was also found that if at least part of the ester groups providing the associative covalent bonds of the dually crosslinked polymer network, and at least part of the hydroxyl groups comprised in the dually crosslinked polymer network, are present as β-hydroxyesters, this may lead to improved properties of the crosslinked polymer composition, such as improved healing kinetics. In a particular embodiment, the present invention provides a polymer network composition as defined herein, wherein at least part of the ester groups providing the associative covalent bonds of the dually crosslinked polymer network, and at least part of the hydroxyl groups comprised in the dually crosslinked polymer network, are present as β-hydroxyesters. In specific embodiments of the invention, substantially all of the ester groups providing the associative covalent bonds of the dually crosslinked polymer network, are β-hydroxyesters. In more specific embodiments of the invention, all of the ester groups providing the associative covalent bonds of the dually crosslinked polymer network, are β-hydroxyesters.

In the context of the present invention, the term “at least part of” refers to a definite, non-zero, portion of the item it refers to. The term “at least part of” may therefore refer to about 1%, 2%, 3%, 5%, 10%, 20%, 25%, 30%, 40%, 50%, 60%, 70%, 75%, 80%, 85%, or substantially all, such as about 90%, 95%, 99%, and even about 100%, of the item it refers to.

In the context of the present invention, the term “substantially all” refers a portion of at least 90% of the item it refers to, preferably at least 95%, more preferably at least 99%, and preferably 100% of the item it refers to.

In the context of the present invention, a β-hydroxyester is meant to be a chemically defined structure, which may be obtained from the reaction of a carboxylic acid group and an oxirane or epoxy group, as schematically represented in Scheme 2.

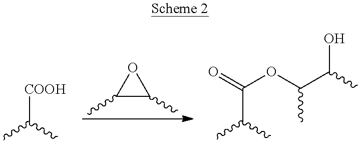

It was further found that if at least part of the ester groups providing the associative covalent bonds of the dually crosslinked polymer network, and at least part of the hydroxyl groups comprised in the dually crosslinked polymer network, are present as β-hydroxyesters, and the β-hydroxyesters are obtained from the reaction of carboxylic acid groups of a pre-polymer with oxirane or epoxy groups of another pre-polymer, such as an epoxidized vegetable oil, this may lead to improved properties of the crosslinked polymer composition, such as improved healing kinetics.

In useful embodiments of the invention, at least part of the ester groups providing the associative covalent bonds of the dually crosslinked polymer network, and at least part of the hydroxyl groups comprised in the dually crosslinked polymer network, are present as β-hydroxyesters represented by formula (I);

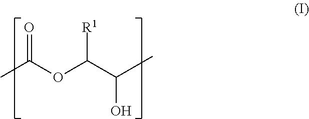

wherein R₁ is selected from —H, —C₁₋₁₈alkyl, and —C₂₋₁₈alkenyl; wherein each of said —C₁₋₁₈alkyl, and —C₂₋₁₈alkenyl is optionally and independently substituted with from 1 to 3 substituents selected from -halo, —OH, —C₁₋₆alkyl, —C₁₋₆alkenyl, and —O—C₁₋₆alkyl.

It further appeared that if at least part of the furan groups of the Diels-Alder bonds are connected to the polymer network via a β-hydroxyester linker, this may lead to improved properties of the crosslinked polymer composition, such as improved healing kinetics. Without willing to be bound to any theory, it is believed that the healing process may be accelerated by the presence of hydrogen bonds close to the Diels-Alder bonds. It should be appreciated that the β-hydroxyester linker connecting furan groups of the Diels-Alders bonds to the polymer network are not considered associative covalent bonds providing crosslinking of the polymer network as defined in the first aspect of the invention. In a particular embodiment, the present invention provides a polymer network composition as defined herein, wherein at least part of the furan groups of the Diels-Alder bonds are connected to the polymer network via a β-hydroxyester linker. In specific embodiments of the invention, substantially all of the furan groups of the Diels-Alder bonds are connected to the polymer network via a β-hydroxyester linker. In more specific embodiments of the invention, all of the furan groups of the Diels-Alder bonds are connected to the polymer network via a β-hydroxyester linker.

It also appeared that that if at least part of the furan groups of the Diels-Alder bonds are connected to the polymer network via a β-hydroxyester linker, and the β-hydroxyester linkers are obtained from the reaction of carboxylic acid groups of a pre-polymer with a furan introducing reagent comprising an oxirane or epoxy group, such as furan glycidyl ether, this may lead to improved properties of the crosslinked polymer composition, such as improved healing kinetics.

In useful embodiment of the invention, at least part of the furan groups of the Diels-Alder bonds are connected to the polymer network via a β-hydroxyester linker, as represented by formula (II);

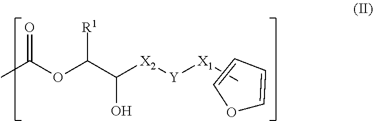

wherein
R₁ is selected from —H, —C₁₋₁₈alkyl, and —C₂₋₁₈alkenyl; wherein each of said —C₁₋₁₈alkyl, and —C₂₋₁₈alkenyl is optionally and independently substituted with from 1 to 3 substituents selected from -halo, —OH, —C₁₋₆alkyl, —C₁₋₆alkenyl, and —O—C₁₋₆alkyl;
Y is selected from —C₁₋₆alkylene-, —O—, —C(O)O—, and —OC(O)—; and
X₁, and X₂ are independently selected from —C₁₋₆alkyl-, —C₂₋₆alkenyl-, and —C₁₋₆alkyl-O—; wherein each of said —C₁₋₆alkyl-, —C₂₋₆alkenyl-, and —C₁₋₆alkyl-O— is optionally and independently substituted with from 1 to 3 substituents selected from -halo, —OH, —C₁₋₆alkyl, —C₁₋₆alkenyl, and —O—C₁₋₆alkyl.

It appeared that if a radical scavenger is present in the crosslinked polymer composition, it may lead to improved properties of the crosslinked polymer composition, for instance by at least partly suppressing the irreversible homopolymerization of the maleimide groups. In a particular embodiment, the present invention provides a polymer network composition as defined herein, further comprising a radical scavenger. Any radical scavenger known in the art capable of suppressing monomer homopolymerization may be suitably used. Suitable examples are hydroquinone, butylated hydroxytoluene, 4-tert-butylcatechol, methyl-p-benzoquinone, and the like. In useful embodiments of the invention, the polymer network composition as defined herein further comprises a radical scavenger selected from the list comprising hydroquinone, butylated hydroxytoluene, 4-tert-butylcatechol, methyl-p-benzoquinone, and any combination thereof.

As stated hereinbefore, according to a second aspect, the present invention provides a method for preparing the polymer network composition, comprising a dually crosslinked polymer network, as defined herein, the method comprising the steps of:
a) providing a first pre-polymer comprising carboxylic acid groups;
b) functionalizing a first portion of carboxylic acid groups of the first pre-polymer with a furan introducing reagent in the presence of a transesterification catalyst, thereby obtaining a furan-functionalized pre-polymer comprising a second portion of carboxylic acid groups;
c) adding a second pre-polymer comprising oxirane or epoxy groups and a third pre-polymer comprising maleimide groups to the furan-functionalized pre-polymer, thereby obtaining a pre-polymer mixture; and
d) stirring the pre-polymer mixture at an elevated temperature, thereby obtaining the polymer network composition;
wherein the first portion is at least 5% of the total amount of carboxylic acid groups of the first pre-polymer.

It was found that a method as described in the second aspect, wherein a first pre-polymer comprising carboxylic acid groups is first reacted with a furan introducing reagent in the presence of a transesterification catalyst to functionalize a first portion of the carboxylic groups, and subsequently reacting the furan-functionalized pre-polymer, still comprising a second portion of the carboxylic groups, with a second pre-polymer comprising oxirane or epoxy groups and a third pre-polymer comprising maleimide groups, provides a crosslinked polymer composition as defined herein. The second portion of the carboxylic acid groups of the furan-functionalized pre-polymer may react with the oxirane or epoxy groups of the second pre-polymer, thereby providing ester groups as associative covalent bonds crosslinking the network, as well as hydroxyl groups, in particular β-hydroxyester groups. The furan groups of the furan-functionalized pre-polymer may react with the maleimide groups of the third pre-polymer, leading to Diels-Alder reaction products of maleimide groups and furan groups as dissociative covalent bonds also crosslinking the network. The first and second portions of the carboxylic acid groups combined make up for substantially all of the carboxylic acid groups of the first pre-polymer.

It was further found that crosslinking the furan-functionalized pre-polymer, the second pre-polymer comprising oxirane or epoxy groups, and the third pre-polymer comprising maleimide groups, in step d) of the method defined herein, at an elevated temperature provides an efficient reaction to obtain the polymer network composition according to the invention. In an embodiment, the present invention provides a method for preparing the polymer network composition as defined herein, wherein the pre-polymer mixture in step d) is stirred at a temperature of at least 50° C., preferably at least 70° C., more preferably a temperature from 100 to 150° C. In another embodiment, the present invention provides a method for preparing the polymer network composition as defined herein, wherein the pre-polymer mixture in step d) is stirred at an elevated temperature for a least 2 hours, preferably from 4 to 16 hours.

Scheme 3 provides a schematic representation of the preparation of a polymer network composition according to embodiments of the invention, wherein a first pre-polymer comprising carboxylic acid groups (PRE-POLYMER 1) is partially (a first portion of the carboxylic acid groups) functionalized with furan groups by reaction with furfuryl glycidyl ether (FGE) in the presence of a transesterification catalyst, and subsequently (the remaining second portion of the carboxylic acid groups) reacted with a second pre-polymer comprising oxirane or epoxy groups (PRE-POLYMER 2) leading to associative covalent bonds (ACB) and a third pre-polymer comprising maleimide groups (PRE-POLYMER 3) leading to dissociative bonds (DCB), both crosslinking the polymer network.

Depending on the stoichiometry of carboxylic acid groups of the first pre-polymer and the furan introducing reagent, the amount of dissociative covalent bonds, relative to the sum of dissociative and associative covalent bonds crosslinking the network, of the crosslinked polymer composition may change. For instance, if the first portion of carboxylic acid groups which is reacted with a furan introducing reagent is 5% of the total amount of carboxylic acid groups of the first pre-polymer, then the furan-functionalized pre-polymer comprises a second portion of 95% remaining carboxylic acid groups. Reaction of this furan-functionalized pre-polymer with the second and third pre-polymer at an elevated temperature, wherein substantially all the furan groups of the furan-functionalized pre-polymer react with the maleimide groups of the third pre-polymer, and wherein substantially all of the remaining carboxylic acid groups of the furan-functionalized pre-polymer, i.e. the second portion of carboxylic acid groups, react with the oxirane or epoxy groups of the second pre-polymer, provides a polymer network composition encompassed by the invention, wherein the amount of dissociative covalent bonds, relative to the sum of dissociative and associative covalent bonds crosslinking the network, is 5%.

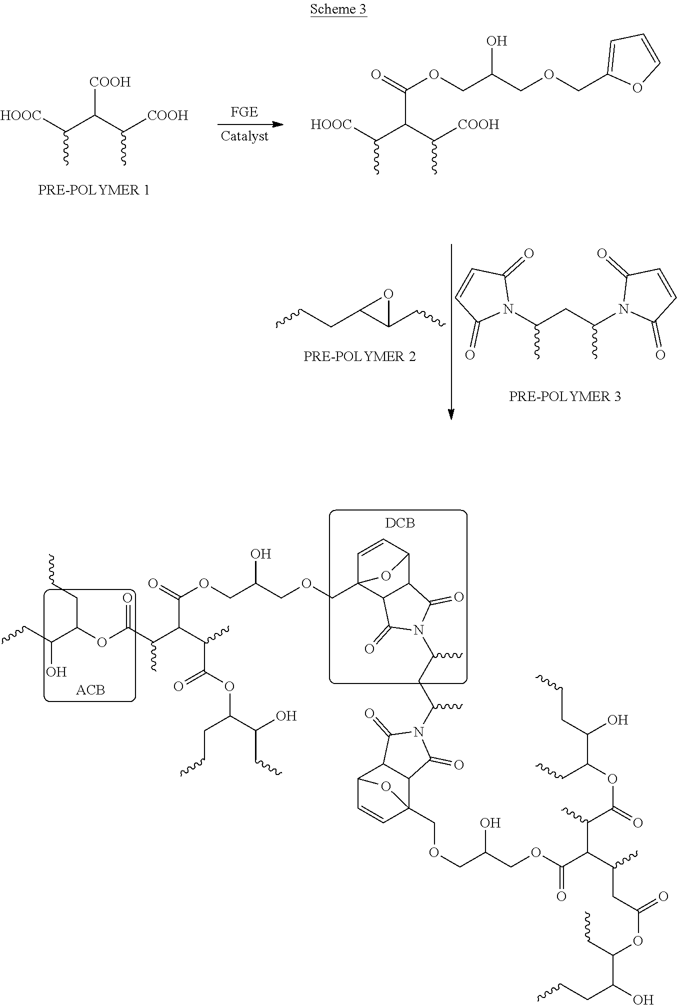

To react or functionalize for instance 5% of the total amount of carboxylic acid groups of the first pre-polymer with furan groups, the stoichiometry of the first pre-polymer and the furan introducing reagent is determined in molar equivalents of available carboxylic acid groups versus the molar equivalents of the furan introducing reagent. In a similar way, the stoichiometry of the second pre-polymer may be chosen to react substantially all of the furan groups of the furan-functionalized pre-polymer, i.e. to have about a 1:1 ratio of furan groups versus maleimide groups, again determined in molar equivalents. In a similar way, the stoichiometry of the third pre-polymer may be chosen to react substantially all of the remaining carboxylic acid groups of the furan-functionalized pre-polymer, i.e. to have about a 1:1 ratio of carboxylic acid groups versus oxirane or epoxy groups, again determined in molar equivalents.

As stated hereinbefore, the amount of Diels-Alder reaction products of maleimide groups and furan groups as dissociative covalent bonds crosslinking the polymer network, relative to the total amount of covalent crosslinks of the polymer network, may have an influence on the properties of the crosslinked polymer composition. In useful embodiments of the invention, the first portion of carboxylic acid groups of the first pre-polymer, relative to the total amount of carboxylic acid groups of the first polymer, is at least 5%, such as 5%, 10%, 15% 20%, 25%, 30%, 35%, 40%, 50%, 60%, 70%, 75%, 80%, 85%, 90%, 95%, or 99%. In a particular embodiment, the present invention provides a method for preparing the polymer network composition as defined herein, wherein the first portion of carboxylic acid groups of the first pre-polymer, relative to the total amount of carboxylic acid groups of the first polymer, is at least 10%, preferably from 20 to 99%, more preferably from 30 to 95%.

In useful embodiments of the invention, at least 0.5 mol % of the transesterification catalyst, relative to the molar equivalents of carboxylic acid groups in the first pre-polymer, is used in step b) of the method as defined herein. In a particular embodiment, the present invention provides a method for preparing the polymer network composition as defined herein, wherein the amount of transesterification catalyst applied in step b), relative to the molar equivalents of carboxylic acid groups in the first pre-polymer, is at least 0.5 mol %, preferably at most 15 mol %, more preferably from 1 to 10 mol %, even more preferably from 3 to 8 mol %.

As stated hereinbefore, adding a radical scavenger to the crosslinked polymer composition may lead to improved properties of the crosslinked polymer composition, for instance by at least partly suppressing the irreversible homopolymerization of the maleimide groups. In an embodiment, the present invention provides a method for preparing the polymer network composition as defined herein, wherein a radical scavenger is added in any one of the steps before the pre-polymer mixture is stirred at the elevated temperature. In a particular embodiment, the present invention provides a method for preparing the polymer network composition as defined herein, wherein a radical scavenger is added in step b) or in step c).

It was further found that when a pre-polymer comprising maleimide groups with a functionality of at least 2, may lead to improved properties of the crosslinked polymer composition. Unless provided otherwise, the functionality should be understood as the number of maleimide groups on the pre-polymer comprising maleimide groups. In an embodiment, the present invention provides a method for preparing the polymer network composition as defined herein, wherein the pre-polymer comprising maleimide groups has a functionality of at least 2. In a particular embodiment, the present invention provides a method for preparing the polymer network composition as defined herein, wherein the pre-polymer comprising maleimide groups is a bismaleimide.

According to another aspect, the present invention provides the use of the polymer network composition as defined herein.

It appeared that the polymer network composition as defined herein is particularly suitable to be used as self-healing material. It further appeared that the crosslinked polymer composition as defined herein is particularly suitable to be used in the field of robotics, more specifically in the subfield of soft robotics. It was also found that the polymer network composition as defined herein provides shape-memory properties, and therefore may be used as a shape-memory material.

As used herein and unless provided otherwise, the term “soft robotics” should be understood as a subfield of robotics covering the construction of robotic parts and robots from different types of materials approaching the properties of those found in living organisms. These materials often require a certain amount of flexibility and adaptability depending on their specific purpose.

Shape-memory is a known term in the art and refers to the ability of certain materials to ‘remember’ and return to their original shape after being deformed. This property is often induced through a phase transition in the material, such as a change in temperature or stress. When subjected to a specific stimulus, such as heating or cooling, these materials can undergo reversible deformation, making them valuable in situations where precise shape changes are required.

It appeared that the shape-memory properties of the polymer network composition as defined herein, may be attributed to the combination of dissociative covalent bonds as well as associative covalent bonds in the polymer network composition as herein provided. More specifically, and without willing to be bound to any theory, it appeared that shape-memory of the the polymer network composition as defined herein may be possible by relaxing only the dissociative bonds while the network is hold together by the associative bonds. The dissociated bonds may thereby allow enough mobility of the polymer chains in order to change the shape and to form new dissociative bonds to hold the new shape once the material is cooled down. Once the sample is heated up again, the stress that was stored in the vitrimers part of the network is released and the sample can recover its original shape.

In an embodiment, the present invention provides the use of the polymer network composition as defined herein, as self-healing material. In a further embodiment, the present invention provides the use of the polymer network composition as defined herein, as shape-memory material. In another embodiment, the present invention provides the use of the polymer network composition as defined herein, in the manufacturing of 1D, 2D or 3D structures. In a particular embodiment, the present invention provides the use of the polymer network composition as defined herein, in the manufacturing of robotic components, seals, gaskets, or tyres. In yet another embodiment, the present invention provides the use of the polymer network composition as defined herein, in a manufacturing method selected from filament extrusion, extrusion-based printing techniques, selective laser sintering, injection molding, compression molding, casting, and soft lithography. In a particular embodiment, the present invention provides the use of the polymer network composition as defined herein, in extrusion-based printing techniques selected from fused filament fabrication, direct ink writing, and the like.

It was further found that the optimal amount of dissociative covalent bonds, relative to the sum of dissociative and associative covalent bonds crosslinking the network, may be different for the intended application. In other words, the polymer network compositions as defined herein, may be tailored for specific applications.

It was for instance found that for 3D printing, improved results may be obtained when the amount of dissociative covalent bonds, relative to the sum of dissociative and associative covalent bonds crosslinking the network, is at least 60%, preferably from 60 to 90%, more preferably from 65 to 75%. Without willing to be bound to any theory, it is believed that the dissociative Diels-Alder bonds allow the network to flow through the nozzle and improve the interlayer adhesion, while the associative ester bonds hold the shape of the sample during deposition.

It was for instance also found that for shape-memory materials, improved results may be obtained when the amount of dissociative covalent bonds, relative to the sum of dissociative and associative covalent bonds crosslinking the network, is at least 30%, preferably from 40 to 70%, even more preferably from 40 to 60%. Without willing to be bound to any theory, it is believed that an improved balance between relaxing mainly the dissociative bonds while maintaining the shape of the network by the associative bonds may be obtained by these ratios of dissociative and associative bonds.

According to yet another aspect, the present invention provides a 1D, 2D or 3D structure comprising the polymer network composition as defined herein. In a particular embodiment, the present invention provides the 1D, 2D or 3D structure as defined herein, wherein the structure is selected from robotic components, seals, gaskets, or tyres.

The compounds of the present invention can be prepared according to the method(s) provided in the examples hereinafter, but those skilled in the art will appreciate that these are only illustrative for the invention and that the compounds of this invention can be prepared by any of several standard synthetic processes commonly used by those skilled in the art of organic chemistry.

As described herein before, the self-healing characteristics of the crosslinked polymer composition depend on the Diels-Alder reaction products of maleimide groups and furan groups as dissociative covalent crosslinking moieties on the one hand and the ester groups as associative covalent crosslinking moieties on the other hand.

### EXAMPLES

### Materials

Succinic anhydride (SA), itaconic anhydride (IA), maleic anhydride (MA), castor oil (CO; 164 mg KOH/g), zinc (II) acetylacetonate, 1,1′-(methylenedi-4,1-phenylene)bismaleimide (DPBM) and 4-tert-butylcatechol were obtained from Sigma Aldrich. Furfuryl glycidyl ether (FGE) was obtained from BLD Pharmatech GmbH (Kaiserslautern, Germany). Epoxidized soybean oil (SO) was obtained from Varteco (Santa Fe, Argentina). BMI-689 was obtained from Designer molecules (Willow Creek, San Diego). Pripol 1040 was obtained from Croda. All products were used as received unless stated otherwise.

### Analysis

¹H NMR was performed on a Bruker Avance DRX 250 with an opening frequency of 250 MHz. The analysis was performed at room temperature using CDCl₃ as a solvent and TMS as internal standard. The measured samples had a concentration of 10 mg m⁻¹.

Fourier transform infrared (FTIR) spectroscopy was performed on a Nicolet 6700 FTIR spectrometer from Thermo Scientific at ambient temperature, using OMNIC as a software package. All spectra are averaged from 32 scans, which are recorded between 4000 cm⁻¹ and 600 cm⁻¹.

Differential scanning calorimetry (DSC) was performed on a TA Instruments Discovery DSC equipped with a refrigerated cooling system (RCS). All the experiments were performed in Tzero aluminum pans in non-hermetic conditions, using nitrogen as purge gas and a heating/cooling rate of 5° C. min-1.

Dynamic mechanical analysis (DMA) was performed on a TA Instruments DMA Q800 equipped with a nitrogen gas cooling accessory. Stress-strain tensile tests were performed at room temperature using a film tension clamp. Rectangular specimens with a thickness of 1.25 mm and 5 mm width were clamped with a distance between clamps of 5 mm and strained at a rate of 60% min-1. The Young's modulus was determined in the initial linear region of the stress-strain curve (0-1% strain).

Dynamic rheometry was performed with a TA instrument Discovery Hybrid Rheometer (DHR2). The samples were cut into circles and put in between 8 mm diameter aluminium parallels plates. Three tests were performed on the materials.
1. The samples were subjected to an oscillatory strain of 1% at different frequencies: 0.312, 0.562, 1.0, 1.778, and 3.125 Hz. At the same time a temperature ramp between 40° C. and 120° C. to determine the gelation transition temperature.
2. The samples were subjected to an oscillatory strain of 1% at a frequency ramp between 0.01 rad/s and 300 rad/s. At temperatures of 90° C., 120° C., 140° C., and 160° C.
3. Stress-relaxation experiments were performed at different temperatures (200-90° C., using a constant shear strain of 1%, within the linear viscoelastic region.

### Synthesis

### Example 1. Preparation of a Pre-Polymer with Carboxylic Acid Groups

Ring-opening esterification was performed on castor oil using maleic anhydride (MA). The reaction was performed under an N₂ atmosphere, without solvent and magnetically stirred. A molar proportion of 1:1 between the hydroxyl groups from the castor oil and the anhydride was used. The esterification reaction was performed at 100° C. for 24 h. The resulting maleinized castor oil (mCO) was used without any further purification.

### Example 2 Preparation of a Pre-Polymer with Carboxylic Acid Groups

Ring-opening esterification was performed on castor oil using itaconic anhydride (IA). The reaction was performed under an N₂ atmosphere, without solvent and magnetically stirred. A molar proportion of 1:1 between the hydroxyl groups from the castor oil and the anhydride was used. The esterification reaction was performed at 100° C. for 24 h. The resulting itaconized castor oil (iCO) was used without any further purification.

### Example 3 Preparation of a Pre-Polymer with Carboxylic Acid Groups

Ring-opening esterification was performed on castor oil using succinic anhydride (SA). The reaction was performed under an N₂ atmosphere, without solvent and magnetically stirred. A molar proportion of 1:1 between the hydroxyl groups from the castor oil and the anhydride was used. The esterification reaction was performed at 130° C. for 24 h. The resulting succinized castor oil (sCO) was used without any further purification.

### Example 4. Partial Functionalization of a Pre-Polymer Comprising Carboxylic Acid Groups With Furan Groups to Obtain a Furan-Functionalized Pre-Polymer

Furfuryl glycidyl ether (FGE) was directly mixed with mCO prepared according to Example 1. The molar ratio of FGE relative to the carboxylic acid groups of the mCO varied from 0.05 to 0.95. Zn(II) acetylacetonate at a 5 mol % relative to the carboxylic acid groups of the mCO was added to the mixture. The functionalization reaction was performed at 100° C. for 5 h under an N₂ atmosphere, without solvent and magnetically stirred. The resulting furan functionalized maleinized castor oil (FmCO) was used in the following steps without any further purification.

Table 1 provides an overview of the composition Examples 4a-4e, with different molar ratios of FGE relative to the carboxylic acid groups of the mCO.

TABLE 1
Composition data of Examples 4a-4e

| | Example | Example | Example | Example | Example |
|---|---|---|---|---|---|
| | 4a | 4b | 4c | 4d | 4e |
| mCO (g) | 48.38 | 51.66 | 55.42 | 58.84 | 62.72 |
| FGE (g) | 16.10 | 12.67 | 8.74 | 5.15 | 1.10 |
| Zn(acac)₂ (g) | 2.15 | 2.30 | 2.47 | 2.62 | 2.79 |
| Molar ratio | 0.95 | 0.7 | 0.45 | 0.25 | 0.05 |
| FGE/COOH | | | | | |

### Example 5. Partial Functionalization of a Pre-Polymer Comprising Carboxylic Acid Groups with Furan Groups to Obtain a Furan-Functionalized Pre-Polymer

Furfuryl glycidyl ether (FGE) was directly mixed with iCO prepared according to Example 2. The molar ratio of FGE relative to the carboxylic acid groups of the iCO varied from 0.05 to 0.95. Zn(II) acetylacetonate at a 5 mol % relative to the carboxylic acid groups of the iCO was added to the mixture. The functionalization reaction was performed at 120° C. overnight under an N₂ atmosphere, without solvent and magnetically stirred. The resulting furan functionalized itaconized castor oil (FiCO) was used in the following steps without any further purification.

Table 2 provides an overview of the composition of Examples 5a-5e, with different molar ratios of FGE relative to the carboxylic acid groups of the iCO.

TABLE 2
Composition data of Examples 5a-5e

| | Example | Example | Example | Example | Example |
|---|---|---|---|---|---|
| | 5a | 5b | 5c | 5d | 5e |
| iCO (g) | 49.17 | 52.44 | 56.19 | 59.60 | 63.44 |
| FGE (g) | 15.86 | 12.46 | 8.59 | 5.06 | 1.08 |
| Zn(acac)₂ (g) | 2.19 | 2.34 | 2.50 | 2.65 | 2.83 |
| Molar ratio | 0.95 | 0.7 | 0.45 | 0.25 | 0.05 |
| FGE/COOH | | | | | |

### Example 6. Partial Functionalization of a Pre-Polymer Comprising Carboxylic Acid Groups with Furan Groups to Obtain a Furan-Functionalized Pre-Polymer

Furfuryl glycidyl ether (FGE) was directly mixed with sCO prepared according to Example 1. The molar ratio of FGE relative to the carboxylic acid groups of the sCO varied from 0.05 to 0.95. Zn(II) acetylacetonate at a 5 mol % relative to the carboxylic acid groups of the sCO was added to the mixture. The functionalization reaction was performed at 100° C. for 5 h under an N₂ atmosphere, without solvent and magnetically stirred. The resulting furan functionalized succinized castor oil (FsCO) was used in the following steps without any further purification.

Table 3 provides an overview of the composition of Examples 6a-6e, with different molar ratios of FGE relative to the carboxylic acid groups of the sCO.

TABLE 3
Composition data of Examples 6a-6e

| | Example | Example | Example | Example | Example |
|---|---|---|---|---|---|
| | 6a | 6b | 6c | 6d | 6e |
| sCO (g) | 48.50 | 51.78 | 55.53 | 58.95 | 62.82 |
| FGE (g) | 16.07 | 12.64 | 8.72 | 5.14 | 1.1 |
| Zn(acac)₂ (g) | 2.16 | 2.31 | 2.47 | 2.63 | 2.80 |
| Molar ratio | 0.95 | 0.7 | 0.45 | 0.25 | 0.05 |
| FGE/COOH | | | | | |

### Example 7. Partial Functionalization of a Pre-Polymer Comprising Carboxylic Acid Groups with Furan Groups to Obtain a Furan-Functionalized Pre-Polymer

Furfuryl glycidyl ether (FGE) was directly mixed with Pripol 1040. The molar ratio of FGE relative to the carboxylic acid groups of the Pripol 1040 varied from 0.3 to 0.85. Zn(II) acetylacetonate at a 5 mol % relative to the carboxylic acid groups of the Pripol 1040 was added to the mixture. The functionalization reaction was performed at 100° C. for 5 h under an N₂ atmosphere, without solvent and magnetically stirred. The resulting furan functionalized Pripol 1040 (FP1040) was used in the following steps without any further purification.

Table 4 provides an overview of the composition of Examples 7a-7e, with different molar ratios of FGE relative to the carboxylic acid groups of the Pripol 1040.

TABLE 4
Composition data of Examples 7a-7e

| | Example | Example | Example | Example | Example |
|---|---|---|---|---|---|
| | 7a | 7b | 7c | 7d | 7e |
| Pripol | 39.88 | 41.83 | 43.24 | 44.75 | 48.11 |
| 1040 (g) | | | | | |
| FGE (g) | 17.65 | 15.25 | 13.51 | 11.65 | 7.52 |
| Zn(acac)₂ (g) | 1.78 | 1.86 | 1.92 | 1.99 | 2.14 |
| Molar ratio | 0.85 | 0.70 | 0.60 | 0.50 | 0.30 |
| FGE/COOH | | | | | |

### Example 8. Reaction of the Furan-Functionalized Pre-Polymers with the Second and Third Pre-Polymers Comprising Oxirane or Epoxy Groups and Maleimide Groups Respectively

FmCO, FICO, FsCO and FP1040, prepared according to Examples 4-7 respectively, were crosslinked using epoxidized soybean oil (ESO) and one of the two different bismaleimides, being 1,1′-(methylenedi-4,1-phenylene)bismaleimide (DPBM) and a commercial low viscosity bismaleimide (BMI-689).

For the preparation of the networks, the furan functionalized materials (FmCO, FICO, FsCO and FP1040) were mixed with:
1. a bismaleimide in a molar ratio of 1:1 to the furan groups in the furan-functionalized pre-polymers;
2. epoxidized soybean oil in a molar ratio of 1:1 to the remaining carboxylic acid groups in the furan-functionalized pre-polymers;
3. 1 wt. % of 4-tertbutylcatechol, relative to the total mass of the pre-polymer mixture.

Table 5 provides an overview of the composition of Examples 8a-8e.

TABLE 5
Composition data of Examples 8a-8e

| | Example | Example | Example | Example | Example |
|---|---|---|---|---|---|
| | 8a | 8b | 8c | 8d | 8e |
| Pripol | 39.88 | 41.83 | 43.24 | 44.75 | 48.11 |
| 1040 (g) | | | | | |
| FGE (g) | 17.65 | 15.25 | 13.51 | 11.65 | 7.52 |
| ESO (g) | 5.05 | 10.60 | 14.61 | 18.90 | 28.44 |
| BMI-689 (g) | 37.42 | 32.33 | 28.64 | 24.70 | 15.93 |
| Zn(acac)₂ (g) | 1.78 | 1.86 | 1.92 | 1.99 | 2.14 |
| Relative | 0.85 | 0.70 | 0.60 | 0.50 | 0.30 |
| amount of | | | | | |
| DCBs | | | | | |

The mixture was heated to 130° C. and mixed with a stirring magnet until the mixture became transparent. Subsequently, the mixture was poured in a PTFE mould and cured in an oven at 130° C. overnight in an oven. Finally, the material was annealed for 1 h at 180° C. in a vacuum oven.

### Comparative Example A. Full Functionalization of a Pre-Polymer Comprising Carboxylic Acid Groups with Furan Groups to Obtain a Furan-Functionalized Pre-Polymer

The furan-functionalized pre-polymer was prepared according to Example 7, but with an FGE to carboxylic acid groups ratio of 1, by reacting Pripol 1040 (38.09 g) with FGE (19.84 g) in the presence of Zn(acac) 2 (1.69 g). The polymer network was prepared according to Example 8, by reacting the furan-functionalized pre-polymer with only BMI-689 (40.38 g). This provided a polymer network composition with only dissociative covalent bonds (100% DA bonds as DCBs).

### Comparative Example B. Full Functionalization of a Pre-Polymer Comprising Carboxylic Acid Groups with a Pre-Polymer Comprising Oxirane or Epoxy Groups

The polymer network was prepared according to Example 8, by reacting Pripol 1040 (53.93 g) without any furan-functionalization with only epoxidized soybean oil (47.87 g) in the presence of Zn(acac) 2 (2.40 g). This provided a polymer network composition with only associative covalent bonds (0% DA bonds as DCBs).

### 3D Printing

Different polymer network compositions according to embodiments of the invention (Examples 8a-8c), as well as Comparative example A, were tested in 3D printing utilizing a Lulzbot Taz 6 3D printer, in which the printer head was substituted with the Pellet Extruder v4 from Mahor.xyz. The G-code file was prepared using Cura LulzBot Edition 3.6.23. The parameters that were used for the printing tests are shown in Table 6.

TABLE 6
Printing parameters

| | Ex. 8c | Ex. 8b | Ex. 8a | CEx. A |
|---|---|---|---|---|
| | 60% DA | 70% DA | 85% DA | 100% DA |
| nozzle size (mm) | 0.5 | 0.5 | 0.5 | 0.5 |
| layer height (mm) | 0.4 | 0.5 | 0.4 | 0.4 |
| line width (mm) | 0.4 | 0.4 | 0.4 | 0.4 |
| infill percentage (%) | 60 | 60 | 60 | 60 |
| flow (%) | 150 | 150 | 160 | 250 |
| printing speed mm/s | 1.25 | 5 | 5 | 4 |
| raster angle (°) | 45 | 45 | 45 | 45 |
| printing temp. (° C.) | 160 | 145 | 160 | 140 |
| bed temperature (° C.) | 85 | 85 | 85 | 85 |

It was found that a polymer network composition with 70% DA bonds as dissociative covalent bonds (Example 8b) provided the best printing results as it was possible to print a 2 cm tall hollow structure. Polymer network compositions with 85% (Example 8a) and 100% DA bonds (Comparative example A) respectively were found to be more liquid, making it difficult to maintain a printed structure, while a polymer network composition with 60% DA bonds (Example 8c) was found to be difficult to be extruded.

### Shape Memory

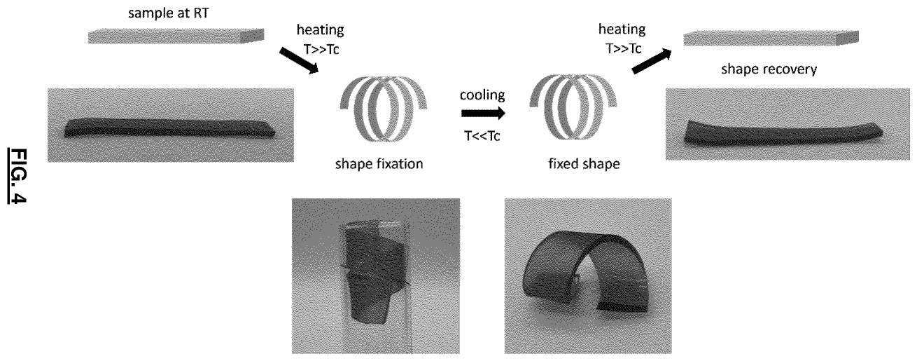

To show the shape-memory properties of the polymer network composition according to the invention, a rectangular sample prepared according to Example 8d, also called the original shape, was put into a curl shape in a glass vial, heated to 110° C. for 30 min in an oven, and allowed to cool down to provide a curled sample, also called the temporary shape. Shape recovery was performed by heating up the curled sample to 110° C. for 10 min in an oil bath. FIG. 4 shows a representation of the different steps described in this section with respect to showing the shape-memory properties, wherein Tc represents the temperature above which at least part of the dissociative bonds dissociate to allow mobility of the polymer chains.

Based on dynamic mechanical analysis of samples with different amounts of dissociative covalent bonds (data not shown), namely 30% (Ex. 8e), 50% (Ex. 8d), and 70% (Ex. 8b) respectively, it was found that the samples with 30% or 50% dissociative covalent bonds showed an improved ability to hold the temporary shape, compared to the sample with 70% dissociative covalent bonds. Based on the same analysis, it was found that the samples with 50% or 70% dissociative covalent bonds showed an improved ability to return to the original shape, compared to the sample with 30% dissociative covalent bonds.

1. A polymer network composition comprising a transesterification catalyst and a polymer network dually crosslinked by Diels-Alder reaction products of maleimide groups and furan groups as dissociative covalent bonds and ester groups as associative covalent bonds; wherein the dually crosslinked network further comprises hydroxyl groups; wherein at least part of the ester groups providing the associative covalent bonds of the dually crosslinked polymer network, and at least part of the hydroxyl groups comprised in the dually crosslinked polymer network, are present as β-hydroxyesters; and wherein the amount of dissociative covalent bonds, relative to the sum of dissociative and associative covalent bonds crosslinking the network, is at least 5%.

2. The polymer network composition as claimed in claim 1, wherein the amount of dissociative covalent bonds, relative to the sum of dissociative and associative covalent bonds crosslinking the network, is at least 10%, preferably from 20 to 99%, more preferably from 30 to 95%, even more preferably from 40 to 90%, yet even more preferably from 50 to 80%.

3. The crosslinked polymer composition as claimed in claim 1 or 2, wherein the β-hydroxyesters are represented by formula (I); 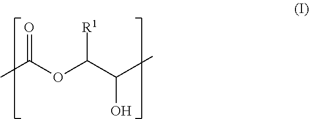
wherein R₁ is selected from —H, —C₁₋₁₈alkyl, and —C₂₋₁₈alkenyl; wherein each of said —C₁₋₁₈alkyl, and —C₂₋₁₈alkenyl is optionally and independently substituted with from 1 to 3 substituents selected from -halo, —OH, —C₁₋₆alkyl, —C₁₋₆alkenyl, and —O—C₁₋₆alkyl.

4. The polymer network composition as claimed in any one of claims 1 to 3, wherein at least part of the furan groups of the Diels-Alder bonds are connected to the polymer network via a β-hydroxyester linker.

5. The polymer network composition as claimed in in any one of claims 1 to 4, wherein at least part of the furan groups of the Diels-Alder bonds are connected to the polymer network via a β-hydroxyester linker, as represented by formula (II); 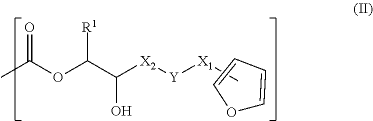
wherein
R₁ is selected from —H, —C₁₋₁₈alkyl, and —C₂₋₁₈alkenyl; wherein each of said —C₁₋₁₈alkyl, and —C₂₋₁₈alkenyl is optionally and independently substituted with from 1 to 3 substituents selected from -halo, —OH, —C₁₋₆alkyl, —C₁₋₆alkenyl, and —O—C₁₋₆alkyl;
Y is selected from —C₁₋₆alkylene-, —O—, —C(O)O—, and —OC(O)—; and
X₁, and X₂ are independently selected from —C₁₋₆alkyl-, —C₂₋₆alkenyl-, and —C₁₋₆alkyl-O—; wherein each of said —C₁₋₆alkyl-, —C₂₋₆alkenyl-, and —C₁₋₆alkyl-O— is optionally and independently substituted with from 1 to 3 substituents selected from -halo, —OH, —C₁₋₆alkyl, —C₁₋₆alkenyl, and —O—C₁₋₆alkyl.

6. The polymer network composition as claimed in any one of claims 1 to 5, further comprising a radical scavenger.

7. The polymer network composition as claimed in any one of claims 1 to 6, wherein the transesterification catalyst is selected from zinc acetylacetonate, zinc acetate, dibutylin oxide, tin (II) 2-ethylhexanoate, triazabicyclodecene, 1-methylimidazole, triphenylphospine, or any combination thereof.

8. A method for preparing the polymer network composition comprising a dually crosslinked polymer network as claimed in claims 1 to 7, the method comprising the steps of:
a) providing a first pre-polymer comprising carboxylic acid groups;
b) functionalizing a first portion of carboxylic acid groups of the first pre-polymer with a furan introducing reagent in the presence of a transesterification catalyst, thereby obtaining a furan-functionalized pre-polymer comprising a second portion of carboxylic acid groups;
c) adding a second pre-polymer comprising oxirane or epoxy groups and a third pre-polymer comprising maleimide groups to the furan-functionalized pre-polymer, thereby obtaining a pre-polymer mixture; and
d) stirring the pre-polymer mixture at an elevated temperature, thereby obtaining the polymer network composition;
wherein the first portion is at least 5% of the total amount of carboxylic acid groups of the first pre-polymer.

9. The method as claimed in claim 8, wherein a radical scavenger is added in any one of the steps before the pre-polymer mixture is stirred at the elevated temperature.

10. The method as claimed in claim 8 or 9, wherein the pre-polymer comprising maleimide groups has a functionality of at least 2, in particular wherein the pre-polymer comprising maleimide groups is a bismaleimide.

11. Use of the polymer network composition as claimed in any one of claims 1 to 7 as self-healing material.

12. Use of the polymer network composition as claimed in any one of claims 1 to 7 in the manufacturing of 1D, 2D or 3D structures, in particular in the manufacturing of robotic components or tyres.

13. Use of the polymer network composition as claimed in any one of claims 1 to 7 in a manufacturing method selected from the list comprising: filament extrusion, extrusion-based printing techniques, selective laser sintering, injection molding, compression molding, casting, soft lithography.

14. Use of the polymer network composition as claimed in claim 13, wherein said extrusion-based printing techniques are selected from the list comprising: fused filament fabrication, direct ink writing and the like.

15. A 1D, 2D or 3D structure comprising the polymer network composition as claimed in any one of claims 1 to 7.
